(19) United States
(12) Patent Application Publication
(10) Pub. No.: US 2019/0106568 A1
(43) Pub. Date: Apr. 11, 2019

(54) HALOGEN FREE FLAME RETARDANT THERMOPLASTIC ELASTOMER COMPOSITIONS CONTAINING CYCLODEXTRINS

(71) Applicant: E. I. DU PONT DE NEMOURS AND COMPANY, Wilmington, DE (US)

(72) Inventors: Eleni Karayianni, Geneva (CH); Alix Dubes, Chambesy (CH)

(73) Assignee: E. I. DU PONT DE NEMOURS AND COMPANY, Wilmington, DE (US)

(21) Appl. No.: 16/088,598

(22) PCT Filed: Mar. 28, 2017
(86) PCT No.: PCT/US17/24481

§ 371 Date: Sep. 26, 2018

Related U.S. Application Data
(60) Provisional application No. 62/315,749, filed on Mar. 31, 2016.

(51) Int. Cl. C08L 71/02; G02B 6/44

(52) U.S. Cl. CPC C08L 71/02; C08L 2203/202; C08L 2201/02; G02B 6/4436

(57) ABSTRACT

Halogen-free flame retardant compositions comprise thermoplastic elastomers that exhibit flame retardance and and are non-dripping according to flammability rating UL 94 V. The flame retardant compositions comprise a) one or more thermoplastic elastomers, and b) a flame retardant mixture comprising: b1) at least one flame retardant comprising a phosphinate or a disphosphinate or a polymer of a polymers phosphinate or a disphosphinate, b2) a phosphonate oligomer, polymer or copolymer, or a phosphorous-containing amino composition; and b3) a cyclodextrin.

### CROSS-REFERENCE TO RELATED APPLICATION

This application claims priority under 35 U.S.C. § 365(c) to U.S. Provisional Application No. 62/315,749, filed on Mar. 31, 2016, which is incorporated herein by reference in its entirety.

### FIELD OF THE INVENTION

The present invention relates to the field of halogen free flame retardant compositions comprising thermoplastic elastomers.

### BACKGROUND OF THE INVENTION

Several patents and publications are cited in this description in order to more fully describe the state of the art to which this invention pertains. The entire disclosure of each of these patents and publications is incorporated by reference herein.

The design flexibility afforded by many thermoplastic resin compositions, their relative light weight and corrosion resistance make them attractive materials for many uses, including the replacement of metal components in many applications including motor and recreational vehicles, appliances, tools, electronics, furniture, and toys. In the construction, furniture, transport or electrical/electronic industries, however, thermoplastic resin compositions are preferably made flame retardant to promote product safety, prevent the spread of fire and reduce destruction of products exposed to fire. The conventional practice of imparting flame retardance to thermoplastic resin compositions has involved the addition of one or more flame retardants or a flame retardant mixture, which typically include a halogenated organic compound, such as brominated polystyrene, as the flame retardant and an antimony compound as a synergist for the retardant.

Disadvantageously, halogenated flame retardants tend to decompose or degrade at the processing temperatures of thermoplastic resins, and potential health and environmental effects result from the gases that are released. Consequently, there has been a trend away from using halogenated flame retardants.

Another conventional approach to impart flame retardance to thermoplastic resin compositions has been the addition of red phosphorus. Int'l. Pat. App. Pub. No. WO 92/20731 describes a composition comprising an elastomer, a flame retardant comprising red phosphorus and ammonium polyphosphate as a flame retardant synergist. In addition, the use of fine red phosphorus powder homogeneously dispersed in the resin is known and practiced. Counterproductively, hazards of fire and explosion are inherent in handling fine red phosphorus powders. Moreover, at typical combustion temperatures in the presence of water vapor, red phosphorus disproportionates to form phosphorus oxoacids and the toxic gas phosphine.

To avert the hazards of using halogenated flame retardants and red phosphorus, they have been replaced with phosphinate salts in some thermoplastic resin compositions. More specifically, phosphinate salts are salts of phosphinic acids, and are also known as phosphinates. For example, DE Pat. Nos. 2,252,258 and 2,447, 727 disclose phosphinates used as flame retardants. U.S. Pat. No. 4,180,495 discloses the use of poly(metal phosphinate) salts in flame retardant polyesters and polyamides. U.S. Pat. No. 6,255,371 discloses flame retardant compositions comprising a) phosphinates, disphosphinates, or polymers of phosphinates and disphosphinates; and b) condensation products of melamine, reaction products of melamine with phosphoric acid, reaction products of condensation products of melamine with phosphoric acid, or mixtures of these products. U.S. Pat. No. 6,270,560 discloses salt mixtures that are made from aluminum phosphinates, aluminum hydroxide, aluminum phosphonates, or aluminum phosphates, and that are suitable as flame retardants for polymeric molding compositions. U.S. Pat. Nos. 5,780,534 and 6,013,707 disclose flame retardant polyester compositions containing calcium or aluminum salts of phosphinic acid or disphosphinic acid.

A disadvantage of using halogen-free, flame retardant compositions is that, upon exposure to flame, such compositions may emit a high level of smoke, which can cause smoke inhalation hazards severe enough to require evacuation of a burning building or the area surrounding a burning object. To address this issue, U.S. Pat. No. 8,781,278 discloses a flame retardant composition comprising a phosphinate salt, a phosphorous-containing amino composition, and a zeolite. While this flame retardant composition is effective in reducing smoke emission, nevertheless it drips when burning.

Recently, the stringency of regulatory standards for flame retardant materials has increased, so as to further enhance the safety of people and the environment in a fire. For example, flame retardant materials should not drip while burning, because this dripping can instantly propagate flames into the surrounding environment. The dripping of burning materials is measured according to UL 94 V, the standard for tests of the flammability of plastic materials that are used as parts in devices and appliances. The UL 94 V standard also provides a method for rating the ignition characteristics of plastic materials.

Therefore, in certain applications, it is desirable that the flame retardant polymer compositions be flame retardant, or that they meet the UL 94 standard for a high degree of flame retardance, in particular the V0 rating in combination with non-dripping behavior during any application of a flame to the material.

Based on the foregoing discussion, it is apparent that a need exists for a flame retardant polymer composition capable of yielding articles that possess excellent flame retardance and good physical properties. It is further apparent that an need exists for compositions with a UL-94 flammability rating of V0 or V1 at 0.8 mm, or a V0 or V1 rating at 0.4 mm, in combination with non-dripping behavior during the application of a flame. A need also exists for articles comprising these compositions.

### SUMMARY OF THE INVENTION

Accordingly, provided herein are flame retardant polymer compositions comprising:

a) one or more thermoplastic elastomers; and

b) a flame retardant mixture comprising:
b1) at least one flame retardant comprising a material selected from the group consisting of phosphinates of the formula (I); disphosphinates of the formula (II); polymers of (I); polymers of (II); copolymers of (I) and (II); and mixtures of two or more of these phosphinates, diphosphinates, polymers and copolymers;

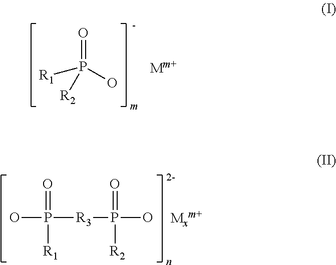

wherein R1 and R2 are independently selected from hydrogen, linear or branched C1-C6 alkyl groups, and aryl groups; R3 is a linear or branched C1-C10 alkylene group, a C6-C10 arylene group, an alkylarylene group or an arylalkylene group; M is selected from the group consisting of calcium, magnesium, aluminum, zinc and mixtures of two or more of calcium, magnesium, aluminum, and zinc; m is 2 to 3; n is 1 or 3; and x is 1 or 2;
b2) at least one flame retardant synergist selected from the group consisting of phosphonate oligomers, polymers or copolymers;

phosphorous-containing amino compositions selected from the group consisting of melamine phosphates, derivatives of melamine phosphates and mixtures of melamine phosphates and their derivatives; and reaction products of ammonia with phosphoric acid, polyphosphates of said reaction products, and mixtures of these reaction products with their polyphosphates; and
b3) at least one cyclodextrin.

In one embodiment, the amount of the flame retardant mixture is from at or about 18 to at or about 50 weight percent, based on the total weight of the flame retardant polymer composition, wherein b1) is present in the flame retardant mixture in an amount greater than or equal to 15 weight percent based on the total weight of the flame retardant polymer composition, and b2) is present in the flame retardant mixture in an amount such that the amount of b2) is less than the amount of b1).

Preferably, the thermoplastic polyester elastomer is a copolyetherester elastomer.

In a preferred embodiment, flame retardant synergist b2) is melamine pyrophosphate, melamine polyphosphate, or ammonium polyphosphate, more preferably melamine pyrophosphate. In an even more preferred embodiment, the amount of melamine pyrophosphate is greater than or equal to 1 weight percent, based on the total weight of the flame retardant polymer composition. Optionally, the flame retardant synergist b2) may additionally comprise a metal hydroxide, such as aluminum trihydoxide or magnesium hydroxide, in an amount from 0 to 8 weight percent based on the total weight of the flame retardant polymer composition.

In another preferred embodiment, the flame retardant synergist b2) is a phosphonate oligomer, polymer or copolymer, preferably phosphonate polymer or copolymer or the combination of phosphonate polymer and copolymer. In a more preferred embodiment, the amount of phosphonate polymers or copolymers, or of the combination of phosphonate polymer and copolymer, is greater than or equal to 1 weight percent, based on the total weight of the flame retardant polymer composition.

In an even more preferred embodiment, the flame retardant polymer composition comprises from at or about 18 to at or about 50 weight percent, preferably from at or about 20 to at or about 40 weight percent of the flame retardant mixture described above, wherein b1) is present in the flame retardant mixture in an amount of from at or about 15 to at or about 25 weight percent, b2) is present in the flame retardant mixture in an amount from at or about 1 to at or about 15 weight percent, and b3) is present in the flame retardant mixture in an amount from at or about 2 to at or about 20 weight percent, preferably from at or about 5 to at or about 10 weight percent, the percentage being based on the total weight of the flame retardant polymer composition.

Further provided herein is a flame retardant composition comprising
A) at least one flame retardant comprising a material selected from the group consisting of phosphinates of the formula (I); disphosphinates of the formula (II); polymers of (I); polymers of (II); copolymers of (I) and (II); and mixtures of two or more of these phosphinates, diphosphinates, polymers and copolymers;

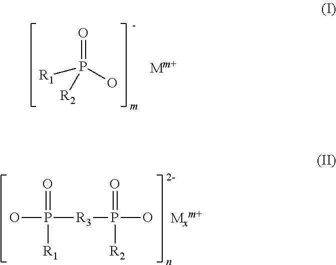

wherein R₁ and R₂ are independently selected from hydrogen, linear or branched C₁-C₆ alkyl groups, and aryl groups; R₃ is a linear or branched C₁-C₁₀-alkylene group, a C₆-C₁₀-arylene group, or an alkylarylene or arylalkylene group; M is selected from the group consisting of calcium, magnesium, aluminum, zinc and mixtures of calcium, magnesium, aluminum, and zinc; m is 2 to 3; n is 1 or 3; and x is 1 or 2,
B) at least one flame retardant synergist selected from the group consisting of phosphonate oligomers, polymers or copolymers; phosphorous-containing amino compositions selected from the group consisting of melamine phosphates, derivatives of melamine phosphates and mixtures of melamine phosphates and their derivatives; and reaction products of ammonia with phosphoric acid, polyphosphates of said reaction products, and mixtures of these reaction products with their polyphosphates; and
C) a cyclodextrin
wherein A) is present in the flame retardant composition in an amount from at or about 40 to at or about 85 weight percent, B) is present in the flame retardant composition in an amount greater than 5 to at or about 25 weight percent, and C) is present in the flame retardant composition in an amount from at or about 10 to at or about 35 weight percent,
provided that the sum A)+B)+C) is 100 weight percent.

Further provided are molded, extruded, or shaped articles comprising the flame retardant composition or the flame retardant polymer composition described herein. Further provided are wires or cables comprising a coating comprising or made from the flame retardant composition or from the flame retardant polymer composition described herein.

### DETAILED DESCRIPTION OF THE INVENTION

The following definitions are to be used to interpret the meaning of the terms discussed in the description and recited in the claims.

Unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The ranges set forth herein include their endpoints unless expressly stated otherwise in limited circumstances. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

Finally, unless stated otherwise, all percentages, parts, ratios, and like amounts, are defined by weight.

Provided herein is a flame retardant polymer composition comprising one or more thermoplastic elastomers; a flame retardant mixture; and a cyclodextrin. The thermoplastic elastomers suitable for use in the flame retardant polymer compositions described herein are preferably present in an amount from at or about 50 to at or about 80 weight percent, based on the total weight of the flame retardant polymer composition, i.e., the sum total of the weights of the one or more thermoplastic elastomers, the flame retardant mixture, the cyclodextrin component, and any optional components that are present. This sum total may also be expressed as the sum of the weights of component a)+b1)+b2)+b3) plus the weights of any optional components.

Preferably, the thermoplastic elastomers include one or more of those defined in ISO 18064:2003(E). Thermoplastic elastomers defined in ISO 18064:2003(E) include copolyester thermoplastic elastomers (TPC), thermoplastic polyamide copolymers (TPA), thermoplastic polyolefinic elastomers (TPO), styrenic thermoplastic elastomers (TPS), thermoplastic polyurethanes (TPU), and combinations of two or more of these thermoplastic elastomers.

Copolyester thermoplastic elastomers (TPC) include copolyesterester elastomers or copolycarbonateester elastomers, copolyesterester urethane elastomers, and copolyetherester elastomers, the latter being preferred.

Copolyesterester elastomers are block copolymers containing a) hard polyester segments and b) soft and flexible polyester segments. Examples of hard polyester segments are polyalkylene terephthalates, poly(cyclohexanedicarboxylic acid cyclohexanemethanol). Examples of soft polyester segments are aliphatic polyesters, including polybutylene adipate, polytetramethyladipate and polycaprolactone. The copolyesterester elastomers contain blocks of ester units of a high melting polyester and blocks of ester units of a low melting polyester which are linked together through ester groups or urethane groups. Copolyesterester elastomers comprising urethane groups may be prepared by reacting the different polyesters in the molten phase, after which the resulting copolyesterester is reacted with a low molecular weight polyisocyanate such as for example diphenylmethylene diisocyanate.

Copolycarbonateester elastomers are block copolymers containing a) hard segments consisting of blocks of an aromatic or semi-aromatic polyester and b) soft segments consisting of blocks of a polycarbonate-containing polymeric component. Suitably, the copolycarbonateester elastomer comprises hard polyester segments made up of repeating units derived from an aromatic dicarboxylic acid and an aliphatic diol, and soft segments comprising repeating units of an aliphatic carbonate. Alternatively, the soft segments may comprise randomly distributed repeating units of an aliphatic carbonate, an aliphatic diol, an aliphatic dicarboxylic acid, a lactone, or a combination of two or more of these repeat units. In these copolymers, the hard segments and the soft segments are connected via urethane groups. These elastomers and their preparation are described in, e.g., EP Pat. No. 0846712.

Copolyetherester elastomers, which are the preferred thermoplastic elastomers in the flame retardant compositions described herein, have a multiplicity of recurring long-chain ester units and short-chain ester units joined head-to-tail through ester linkages, said long-chain ester units being represented by formula (A):

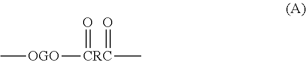

and said short-chain ester units being represented by formula (B):

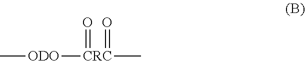

wherein G is a divalent radical remaining after the removal of terminal hydroxyl groups from poly(alkylene oxide)glycols having a number average molecular weight of between about 400 and about 6000, or preferably between about 400 and about 3000;
R is a divalent radical remaining after removal of carboxyl groups from a dicarboxylic acid having a molecular weight of less than about 300;
D is a divalent radical remaining after removal of hydroxyl groups from a diol having a molecular weight less than about 250.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

As used herein, the term “short-chain ester units” as applied to units in a polymer chain of the copolyetheresters refers to low molecular weight compounds or polymer chain units having molecular weights less than about 550. They are made by reacting a low molecular weight diol or a mixture of diols (molecular weight below about 250) with a dicarboxylic acid to form ester units represented by Formula (B) above.

Included among the low molecular weight diols which react to form short-chain ester units suitable for use for preparing copolyetheresters are acyclic, alicyclic and aromatic dihydroxy compounds. Preferred compounds are diols with about 2 to 15 carbon atoms such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. Especially preferred diols are aliphatic diols containing 2 to 8 carbon atoms, and a more preferred diol is 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol).

As used herein, the term “diols” includes equivalent ester-forming derivatives such as those mentioned. However, the molecular weight requirements refer to the corresponding diols, not their derivatives.

Dicarboxylic acids that can react with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes functional equivalents of dicarboxylic acids that have two carboxyl functional groups that perform substantially like dicarboxylic acids in reaction with glycols and diols in forming copolyetherester polymers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are also suitable, provided the corresponding acid has a molecular weight below about 300. The dicarboxylic acids can contain any substituent groups or combinations that do not substantially interfere with copolyetherester polymer formation and use of the copolyetherester polymer in the flame retardant polymer compositions.

As used herein, the term “aliphatic dicarboxylic acids” refers to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because of homopolymerization. However, some unsaturated acids, such as maleic acid, can be used.

As used herein, the term “aromatic dicarboxylic acids” refer to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—. Representative useful aliphatic and cycloaliphatic acids that can be used include sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; and 3,4-furan dicarboxylic acid. Preferred acids are cyclohexane dicarboxylic acids and adipic acid.

Representative aromatic dicarboxylic acids include phthalic, terephthalic and isophthalic acids; bibenzoic acid; substituted dicarboxy compounds with two benzene nuclei such as bis(p-carboxyphenyl) methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives. Hydroxy acids such as p-(beta-hydroxyethoxy)benzoic acid can also be used, provided an aromatic dicarboxylic acid is also used.

Aromatic dicarboxylic acids are a preferred class for preparing suitable copolyetherester elastomers. Among the aromatic acids, those with 8 to 16 carbon atoms are preferred, particularly terephthalic acid alone or with a mixture of phthalic or isophthalic acids.

The copolyetherester elastomer preferably comprises from at or about 15 to at or about 99 weight percent copolymerized residues of short-chain ester units corresponding to Formula (B) above, the remainder being copolymerized residues of long-chain ester units corresponding to Formula (A) above. More preferably, the copolyetherester elastomers comprise from at or about 20 to at or about 95 weight percent, and even more preferably from at or about 50 to at or about 90 weight percent short-chain ester units, where the remainder is long-chain ester units. Still more preferably, at least about 70 mol % of the groups represented by R in Formulae (A) and (B) above are 1,4-phenylene radicals and at least about 70 mol % of the groups represented by D in Formula (B) above are 1,4-butylene radicals and the sum of the percentages of R groups which are not 1,4-phenylene radicals and D groups that are not 1,4-butylene radicals does not exceed 30 mol %. If a second dicarboxylic acid is used to prepare the copolyetherester, isophthalic acid is preferred, and if a second low molecular weight diol is used, ethylene glycol, 1,3-propanediol, cyclohexanedimethanol, or hexamethylene glycol are preferred.

A blend or mixture of two or more copolyetherester elastomers can be used. The copolyetherester elastomers used in the blend need not on an individual basis come within the values set forth above for the elastomers. The blend of two or more copolyetherester elastomers must conform to the values described herein for the copolyetheresters on a weighted average basis, however. For example, in a mixture that contains equal amounts of two copolyetherester elastomers, one copolyetherester elastomer can contain 60 weight percent short-chain ester units and the other resin can contain 30 weight percent short-chain ester units for a weighted average of 45 weight percent short-chain ester units.

Preferred copolyetherester elastomers include, but are not limited to, copolyetherester elastomers prepared from monomers comprising (1) poly(tetramethylene oxide) glycol, (2) a dicarboxylic acid selected from isophthalic acid, terephthalic acid and mixtures thereof, and (3) a diol selected from 1,4-butanediol, 1,3-propanediol and mixtures thereof; or from monomers comprising (1) poly(trimethylene oxide) glycol, (2) a dicarboxylic acid selected from isophthalic acid, terephthalic acid and mixtures thereof, and (3) a diol selected from 1,4-butanediol, 1,3-propanediol and mixtures thereof; or from monomers comprising (1) ethylene oxide-capped poly(propylene oxide) glycol; (2) a dicarboxylic acid selected from isophthalic acid, terephthalic acid and mixtures thereof; and (3) a diol selected from 1,4-butanediol, 1,3-propanediol and mixtures thereof.

Preferably, the copolyetherester elastomers are prepared from esters or mixtures of esters of terephthalic acid or isophthalic acid, 1,4-butanediol and poly(tetramethylene ether)glycol or poly(trimethylene ether) glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetheresters are prepared from esters of terephthalic acid, e.g. dimethylterephthalate, 1,4-butanediol and poly(tetramethylene ether)glycol.

As a result of their excellent tear strength, tensile strength, flex live or flexural endurance, abrasion resistance, and broad useful end-use temperature range, thermoplastic polyetherester elastomers are used in a wide range of applications including for example wire and cable coatings, automotive applications, components for household appliances, components for buildings or mechanical devices and tubes and pipes for conveying fluids. Examples of suitable copolyetherester elastomers are commercially available under the trademark Hytrel® from E. I. du Pont de Nemours and Company, Wilmington, Del.

Thermoplastic polyamide copolymers (TPA) consist of copolymers containing a) hard polyamide segments and b) soft and flexible segments. Examples of suitable TPAs include polyesteramides (PEA), polyetheresteramides (PEEA), polycarbonate-esteramides (PCEA) and polyether-block-amides (PE-b-A). Preferably, the TPA consists of a linear and regular chain of polyamide segments and flexible polyether or polyester segments or soft segments with both ether and ester linkages as represented by formula (C):

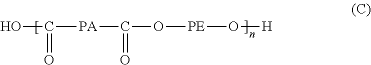

wherein “PA” represents a polyamide sequence and “PE” represents for example a polyoxyalkylene sequence formed from linear or branched aliphatic polyoxyalkylene glycols or a long-chain polyol with either ether or ester linkages, or both, or copolyethers or copolyesters derived therefrom. The polyamide may be aliphatic or aromatic. The softness of the copolyetheramide and the copolyesteramide block copolymers generally decreases as the relative amount of polyamide units is increased. Examples of thermoplastic polyamide block copolymers suitable for use in the compositions described herein are commercially available from Arkema or Elf Atochem under the tradename Pebax™.

Thermoplastic polyolefinic elastomers (TPO) consist of certain rubbery olefin-type polymers, for example propylene or polyethylene, as well as thermoplastics blended with a rubber. Examples of thermoplastic polyolefinic elastomers include random block copolymers, such as alpha-olefin copolymers, including ethylene-propylene copolymers (EPM); ethylene propylene diene copolymers (EPDM); copolymers of ethylene or propylene or butene with higher alpha-olefin copolymers (e.g., ethylene-hexene, ethylene-octene (for example Engage™, which is commercially available from The Dow Chemical Co.)); random stereoblock polypropylene; hydrogenated diene block copolymers, such as hydrogenated polybutadiene and hydrogenated polyisoprene; a mixture of hydrogenated polybutadiene and polybutadiene; and graft copolymers such as EPDM-g-polypivalolactone (PPVL). Other examples are polyolefin blend thermoplastic elastomers, such as for example blends of EPM or EPDM with isotactic polypropylene (iPP), and blends of EPM or EPDM with polyethylene and polypropylene.

Styrenic thermoplastic elastomers (TPS) consist of block copolymers of styrene and rubbery polymeric materials, such as for example polybutadiene (TPS-SBS), a mixture of hydrogenated polybutadiene and polybutadiene, poly(ethylene-butylene) (TPS-SEBS), polyisoprene (TPS-SIS) and poly(ethylene-propylene) (TPS-SEPS).

Thermoplastic polyurethanes (TPU) consist of linear segmented block copolymers composed of hard segments comprising polyisocyanate and a chain extender and soft segments comprising diisocyanate and a long chain polyol as represented by the general formula (D):

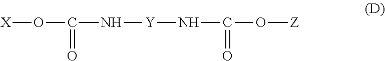

wherein “X” represents a hard segment comprising a polyisocyanate and a chain extender, preferably a short-chain glycol, “Z” represents a soft segment comprising a polyisocyanate and a long-chain polyol and “Y” represents the residual group of the polyisocyanate compound of the urethane bond linking the X and Z segments. Preferably, the polyisocyanate is a diisocyanate. Examples of suitable diisocyanates include, without limitation, 4,4′-diphenylmethane diisocyanate (MDI), toluene diisocyanate (TDI), hexamethylene diisocyanate (HDI), 4,4′-dicyclohexylmethane diisocyanate (H12-MDI), trans-trans-4,4′-dicyclohexylmethane diisocyanate, 3,3′-dimethyl-4,4′-biphenyl diisocyanate (TODI) and 1,4-benzene diisocyanate. The long-chain polyol includes those of a polyether type, such as poly(alkylene oxide)glycol, or those of polyester type.

The flame retardant polymer compositions described herein further comprise a flame retardant mixture b), which may also be referred to herein as a “flame retardant composition”, and which imparts flame retardance to the flame retardant polymer compositions. These flame retardant mixtures b) comprise at least one flame retardant b1) which is a material selected from the group consisting of phosphinates of the formula (I); disphosphinates of the formula (II); polymers of (I); polymers of (II); copolymers of (I) and (II); and mixtures of two or more of these phosphinates, diphosphinates, polymers and copolymers;

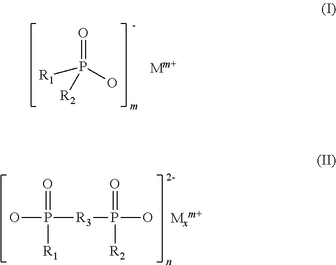

wherein R₁ and R₂ are identical or different and are hydrogen, linear or branched C₁ to C₆ alkyl groups, or aryl groups; R₃ is a linear or branched C₁ to C₁₀-alkylene group, a C₆ to C₁₀-arylene group, an -alkylarylene or -arylalkylene group; M is calcium, magnesium, aluminum, or zinc; m is 2 to 3; n is 1 or 3; and x is 1 or 2.

R₁ and R₂ are preferably hydrogen, methyl, ethyl, n-propyl, isopropyl, n-butyl, tert-butyl, n-pentyl or phenyl. R₃ is preferably methylene, ethylene, n-propylene, isopropylene, n-butylene, tert-butylene, n-pentylene, n-octylene, n-dodecylene, or phenylene or naphthylene, or methylphenylene, ethylphenylene, tert-butylphenylene, methylnaphthylene, ethylnaphthylene or tert-butylnaphthylene, or phenylmethylene, phenylethylene, phenylpropylene or phenylbutylene. M is preferably aluminum or zinc.

Polymers of the compounds of formulas (I) and (II) include species containing oligomers or condensation products of the phosphinate and diphosphinate anion moieties.

Preferred phosphinates are metal salts of organic phosphinates, such as metal salts of methylethylphosphinates and diethylphosphinates. More preferred are aluminum methylethylphosphinate, aluminum diethylphosphinate, zinc methylethylphosphinate, and zinc diethylphosphinate. More preferably, the flame retardant b1) is aluminum phosphinate, magnesium phosphinate, calcium phosphinates or zinc phosphinate and still more preferably, the flame retardant b1) is aluminum phosphinate, aluminum diethyl phosphinate or zinc diethyl phosphinate.

Although the flame retardant composition may contain both a phosphinate and a diphosphinate or a diphosphinate alone, preferred compositions contain phosphinates due to cost and availability.

The flame retardant b1) is usually in the form of particles, which may have any particle size distribution, as commonly understood and used by those having skill in the field, but preferably the phosphinates or diphosphinates have particle sizes (D90 value) of less than or equal to 100 microns and more preferably less than or equal to 20 microns. The D90 value is a particle size that is larger than the particle size of 90 weight percent of the particles, wherein the particle size distribution is measured by the technique of laser diffraction from a suspension of particles in a solvent using a particle size analyzer, for example a Mastersizer 2000 from Malvern. This test method meets the requirements set forth in ISO 13320.

Preferably, the flame retardant mixture b) comprises the flame retardant b1) in an amount from at or about 40 to at or about 85 weight percent, the weight percentage being based on the total weight of the flame retardant mixture, i.e. the sum of components b1)+b2)+b3).

The flame retardant mixtures b2) described herein comprise at least one flame retardant synergist selected from the group consisting of phosphonate oligomers, polymers or copolymers; phosphorous-containing amino compositions selected from the group consisting of melamine phosphates, derivatives of melamine phosphates and mixtures of melamine phosphates and their derivatives; and reaction products of ammonia with phosphoric acid, polyphosphates of said reaction products, and mixtures of these reaction products with their polyphosphates. For example melamine pyrophosphate, ammonium polyphosphate, and mixtures of melamine pyrophosphate and ammonium polyphosphate are suitable flame retardant synergists. The amount of b2) is lower than the amount of b1). Preferably the amount of b2) is greater than 5 to at or about 25 weight percent, the weight percentage being based on the total weight of the flame retardant mixture, i.e. the sum of components b1)+b2)+b3).

Suitable phosphonate oligomers, polymers or copolymers for use as flame retardant synergists b2) are described in US2011/0237695 and US2014/0000751. These may be linear or branched phosphonate oligomers, linear or branched phosphonate polymers, or the phosphonate copolymers may be random or block. They include random polyesterphosphonates and random polycarbonatophosphonates. Preferred phosphonate copolymers are block copolymers, such as a poly(block-phosphonato-ester) or poly(block-phosphonato-carbonate). Preferred phosphonates are homopolymer polyphosphonates sold under the tradename Nofia HM1100 and polyphosphonate-co-carbonate sold under the tradename Nofia COPOs.

Suitable phosphorous-containing amino compositions that are reaction products of ammonia with phosphoric acid or a polyphosphate derivative thereof include ammonium hydrogenphosphate, ammonium dihydrogenphosphate, and ammonium polyphosphate. More preferably, the phosphorous-containing amino composition comprises melamine polyphosphate, melamine pyrophosphate or ammonium polyphosphate. Suitable phosphorous-containing amino compositions that are melamine phosphates include melamine orthophosphate (C₃H₆N₆H₃O₄P), dimelamine orthophosphate (2C₃H₆N₆H₃O₄P), melamine polyphosphate, dimelamine pyrophosphate, and melamine pyrophosphate. Derivatives of melamine phosphates include, for example, melamine polyphosphate, melamine polyphosphate and melamine borophosphates.

The material known as melamine pyrophosphate is a compound defined by the nominal formula (C₃H₆N₆)₂H₄P₂O₇. Commercially available grades of melamine pyrophosphate may have substantial impurities, such as other phosphorous containing anions, or a different ratio of phosphorous to nitrogen. See U.S. Pat. No. 5,814,690. Nevertheless, any compound that has the nominal melamine pyrophosphate above or that is sold commercially as melamine pyrophosphate is suitable for use in the flame retardant composition.

The phosphorous-containing amino composition may also comprise coated particles, for example particles that have a core comprising melamine pyrophosphate and a coating comprising an organosilane, ester, polyol, dianhydride, dicarboxylic acid, melamine formaldehyde, or mixtures thereof. Such coated compositions are described in U.S. Pat. No. 6,015,510. An example of a suitable coated melamine pyrophosphate is a melamine pyrophosphate coated with 0.6±0.1 wt. % Silquest® A-1100 silane. Alternatively, the coating agent may be added to the phosphorous-containing composition in a separate step prior to blending with one or more components of the flame retardant composition, or in a step wherein all components are mixed together. In such cases, the amount of coating agent will generally be in the range of from about 0.1 to about 6 wt. %, based on the weight of the coated phosphorous-containing composition.

The flame retardant mixture b) described herein also comprises from at or about 10 to at or about 35 weight percent of one or more cyclodextrins b3), the weight percentage being based on the total weight of the flame retardant mixture, i.e. the sum of components b1)+b2)+b3). Combinations of two or more native cyclodextrins, combinations of two or more cyclodextrin derivatives, and combinations of at least one native cyclodextrin and at least one cyclodextrin derivative are suitable for use in the flame retardant mixture. Native cyclodextrins, which are produced from starch by means of enzymatic conversion, are cyclic oligosaccharides composed of six (cyclomaltohexaose or a-cyclodextrin), seven (cyclomaltoheptaose or β-cyclodextrin) and eight (cyclomaltooctaose or γ-cyclodextrin) d-glucopyranose residues, linked into a macrocycle by α-(1→4) glycosidic bonds. Cyclodextrin derivatives may be produced, for example, by chemically modifying the native cyclodextrins, for example by one or more of hydroxyalkylation, alkylation or sulfoalkylation. Preferred cyclodextrins include, without limitation, beta-cyclodextrin and its derivatives, such as unsubstituted or native beta-cyclodextrin, methylated-beta-cyclodextrin, and hydroxypropyl-beta-cyclodextrin (HPBCD).

Flame retardant compositions comprising the three components b1), b2) and b3) may be used to impart flame retardancy and non-dripping properties to a wide range of polymers, for example thermoplastics, elastomers and thermoplastic elastomers, including thermoplastic vulcanizates, copolyester thermoplastic elastomers, thermoplastic polyamide copolymers, thermoplastic polyolefinic elastomers, styrenic thermoplastic elastomers, thermoplastic polyurethanes, copolyetherester elastomers, copolyesterester elastomers, polychloroprene, EPDM rubber, fluoroelastomers and ethylene acrylic elastomers.

The flame retardant polymer compositions described herein may further comprise additives that include, but are not limited to, one or more of the following components as well as combinations of two or more of these: metal deactivators, such as hydrazine and hydrazide; heat stabilizers; antioxidants; modifiers; colorants; lubricants; fillers and reinforcing agents; impact modifiers; flow enhancing additives; antistatic agents; crystallization promoting agents; conductive additives; viscosity modifiers; nucleating agents; plasticizers; mold release agents; scratch and mar modifiers; drip suppressants; adhesion modifiers; and other processing aids known in the polymer compounding art. When used, the additives are preferably present in amounts of about 0.1 to about 20 weight percent, based on the total weight of the flame retardant polymer composition.

The flame retardant polymer compositions may further comprise agents that increase softness, such as poly(meth)acrylate rubber, polyethylene/(meth)acrylate rubber, or olefinic copolymers. As used herein, the term “(meth)acrylate” refers to methacrylate or acrylate and the term “poly(meth)acrylate refers to polymers derived from the polymerization of methacrylate or acrylate monomers. The (meth)acrylate rubber may be prepared by copolymerizing one or more (meth)acrylate monomers with one or more olefins. A preferred olefin is ethylene. Preferably, the (meth)acrylate rubbers include poly(alkyl (meth)acrylate) rubbers, ethylene/alkyl (meth)acrylate copolymer rubbers and poly(perfluoroalkyl (meth)acrylate) rubbers. More preferably the (meth)acrylate rubbers are ethylene/alkyl (meth)acrylate copolymer rubbers, in which the alkyl group has from 1 to 4 carbons. Preferred ethylene/alkyl (meth)acrylate copolymers are those derived from less than about 80 weight percent of ethylene and more than about 20 weight percent alkyl (meth)acrylate. The (meth)acrylate rubbers may optionally comprise additional repeat units derived from one or more functionalized comonomers, such as (meth)acrylate glycidyl esters (such as glycidyl methacrylate), maleic acid, or other comonomers having one or more reactive groups, including acid, hydroxyl, epoxy, isocyanate, amine, oxazoline, chloroacetate, or diene functionality. The (meth)acrylate rubbers may also be prepared from more than two (meth)acrylate monomers. Examples are (meth)acrylate rubbers made by polymerizing ethylene, methyl acrylate, and a second acrylate (such as butyl acrylate).

The additives described above may be present in the flame retardant polymer compositions in amounts and in forms known in the art, including in the form of so-called nanomaterials, in which at least one of the dimensions of the particles is in the range of 1 to 1000 nm.

The flame retardant polymer compositions described herein are melt-mixed blends, wherein all of the polymeric components are well-dispersed within each other and all of the non-polymeric ingredients are well-dispersed in and bound by the polymer matrix, such that the blend forms a unified whole.

Any melt-mixing method may be used to combine the polymeric components and non-polymeric ingredients. For example, the polymeric components and non-polymeric ingredients of the flame retardant polymer compositions may be added to a melt mixer, such as, for example, a single or twin-screw extruder; a blender; a single or twin-screw kneader; or a Banbury mixer, either simultaneously through a single step addition, or in a stepwise fashion, and then melt-mixed. When adding the polymeric components and non-polymeric ingredients in a stepwise fashion, part of the polymeric components or non-polymeric ingredients are first added and melt-mixed, and the remaining polymeric components and non-polymeric ingredients are added subsequently and further melt-mixed until a well-mixed composition is obtained. When long-length fillers, such as for example long glass fibers, are used in the composition, pultrusion may be used to prepare a reinforced composition.

The flame retardant polymer compositions described herein may be shaped into articles using methods known to those skilled in the art, such as injection molding, blow molding, injection blow molding, extrusion, thermoforming, melt casting, vacuum molding, rotational molding, calendar molding, slush molding, filament extrusion and fiber spinning. Suitable articles include films, fibers and filaments; wire and cable coatings; photovoltaic cable coatings; optical fiber coatings; tubing and pipes; fabrics or textiles made from fibers and filaments, e.g., for use in clothing or carpets; films and membranes, such as breathable membranes in roofing and building/construction; motorized vehicle parts, such as body panels, air bag doors, dashboards, engine covers, rocker panels or air filter covers; components for household appliances, such as washers, dryers, refrigerators and heating-ventilation-air conditioning appliances; connectors in electrical or electronic applications; components for electronic devices, such as computers; components for office, indoor, and outdoor furniture; and footwear components.

The following examples are provided to describe the invention in further detail. These examples, which set forth specific embodiments and a preferred mode presently contemplated for carrying out the invention, are intended to illustrate and not to limit the invention.

### Examples

### Materials

The following materials were used to prepare the flame retardant polymer compositions described herein and the compositions of the comparative examples.

Copolyester Thermoplastic Elastomer (TPC): a copolyetherester elastomer comprising about 44.9 weight percent of poly(tetramethylene oxide) having an average molecular weight of about 1000 g/mol, the weight percentage being based on the total weight of the copolyetherester elastomer, the short chain ester units of the copolyetherester being polybutylene terephthalate and polybutylene isophthalate segments. As required for the manufacturing process and well-known to those skilled in the art, the copolyetherester elastomer contained up to 6 weight percent of one or more of heat stabilizers, antioxidants, processing aids, antidripping agents, and metal deactivators.

Phosphinate flame retardant: Exolit® OP935, an aluminum salt of diethyl phosphinate having a D90 max of 8 microns and supplied by Clariant.

Melamine pyrophosphate (MPP): MelBan 13-1115 supplied by Hummel Croton, Inc., South Plainfield, N.J., USA, having a particle diameter 100%<20 μm and a mean particle diameter of 3.5 μm.

Phosphonate flame retardant: Nofia HM1100 (experimental code FRX-100), a polyphosphonate, supplied by FRX Polymers, Inc., Chelmsford, Mass., USA.

Boehmite flame retardant: Actilox B60, an aluminium oxide hydroxide having a D90 of 1.7 μm and a specific surface area (BET) of 6 m²/g, supplied by Nabaltec AG, Schwandorf, Germany.

Aluminum Trihydroxide flame retardant (ATH): Hydral 710, having a D95 of 2.1 μm and a surface area of 4.0 m²/g, supplied by J.M. Huber Corporation.

Cyclodextrin 1: Kleptose Beta, a beta-cyclodextrin, supplied by Roquette Freres, Lestrem Cedex, France.

Cyclodextrin 2: Cavamax W7, a beta-cyclodextrin, supplied by Wacker Chemie AG, Munchen, Germany.

In the Table, compositions of the Examples are identified as “E” and compositions of the Comparative Examples are identified as “C”. Table 1 provides a list of components corresponding to compositions E1 to E3 and comparative compositions C1 to C11.

### Test Methods

Flame retardant polymer compositions were prepared as follows: The above described materials in the amounts listed in Table 1 were melt blended in a 30 mm twin screw extruder (Coperion ZSK 30). The compounded melt blended mixture of Example E3 was extruded in the form of laces or strands, cooled in a water bath, chopped into granules, dried and placed in sealed aluminum lined bags in order to prevent absorption or adsorption of water. All other compounded, melt-blended mixtures were extruded in the form of narrow strips (or bands) having an average thickness of 1.6 mm.

The following test methods were used to determine properties:

### Flame Retardance

Flammability testing was performed according to the UL 94 test standard, 20 mm vertical burning test. The test specimens were rectangular bars (125 mm long by 13 mm wide, 1.6 mm thickness). The test specimens of the composition of Example E3 were prepared by injection molding. Test specimens of the remainder of the compositions of the Examples and Comparative Examples were prepared by cutting the narrow strips to size.

Flammability was measured for all compositions after they had been preconditioned for at least 48 hours at 23° C. and 50 percent relative humidity. The test specimens were clamped with the longitudinal axis vertical so that the lower edge of the specimen was 300 mm above a horizontal layer of dry absorbent surgical cotton. A burner producing a blue flame 20 mm high was placed so that the flame was applied centrally to the mid-point of the lower edge of the specimen for 10 seconds. After the application of the flame to the specimen for 10 seconds, the burner was withdrawn from the sample and the after-flame time, t₁, was measured. When after-flaming of the test specimen stopped, the burner was replaced beneath the specimen for an additional 10 seconds. The flame was then withdrawn from the sample and the second after-flame time, t₂, was measured. Materials were classified according to the test specifications as V-0, V-1 or V-2, based on the behavior of the composition during burning. The dripping of burnt material during any of the applications of flame was recorded. The compositions of Examples E1, E2 and E3 have a rating of UL-V0 or UL-V1 and show no dripping during the duration of the flammability test.

While certain of the preferred embodiments of this invention have been described and specifically exemplified above, it is not intended that the invention be limited to such embodiments. Various modifications may be made without departing from the scope and spirit of the invention, as set forth in the following claims.

TABLE 1

| | C1 | C2 | C3 | C4 | C5 | C6 | C7 | C8 | C9 | E1 | C10 | C11 | E2 | E3 |
|---|---|---|---|---|---|---|---|---|---|---|---|---|---|---|
| TPC | 80 | 70 | 78 | 75 | 75 | 70 | 74 | 70 | 71 | 67 | 68 | 73 | 65 | 66.8 |
| Phosphinate | 20 | 30 | 20 | 20 | 20 | 20 | 20 | 20 | 20 | 20 | 20 | 20 | 20 | 18 |
| Phosphonate | | | 2 | 5 | | | 2 | 2 | 5 | 5 | 2 | 2 | 2 | |
| Boehmite | | | | | | | | | | | 2 | 2 | 2 | |
| ATH | | | | | | | | | | | | 3 | 3 | |
| MPP | | | | | | | | | | | | | | 7.2 |
| Cyclodextrin 1 | | | | | 5 | 10 | 4 | 8 | 4 | 8 | 8 | | 8 | |
| Cyclodextrin 2 | | | | | | | | | | | | | | 8 |
| UL-V (t₁ + t₂)_{avg} | 1.2 | 1.1 | 1 | 1.2 | 1 | 1.5 | 1.3 | 1 | 1.2 | 1.5 | 5.8 | 7.0 | 4.4 | 1.3 |
| sec | | | | | | | | | | | | | | |
| UL-V Code 1, | No | No | No | No | No | No | No | No | No | No | No | Yes | No | No |
| dripping | | | | | | | | | | | | | | |
| UL-V Code 2, | Yes | Yes | Yes | Yes | Yes | Yes | Yes | Yes | Yes ¼, | No | Yes | Yes | No | No |
| dripping | | | | | | | | | No ¾ | | | | | |
| UL-V rating | V2 | V2 | V2 | V2 | V2 | V2 | V2 | V2 | V0 | V0 | V2 | V2 | V1 | V0 |

1. A flame retardant polymer composition comprising:
b) one or more thermoplastic elastomers; and
c) a flame retardant mixture consisting of:
b1) at least one flame retardant comprising a material selected from the group consisting of phosphinates of the formula (I); disphosphinates of the formula (II); polymers of (I); polymers of (II); copolymers of (I) and (II); and mixtures of two or more of these phosphinates, diphosphinates, polymers and copolymers; 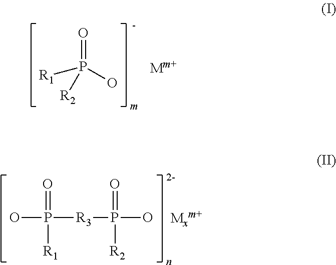
wherein R₁ and R₂ are independently selected from hydrogen, linear or branched C₁-C₆ alkyl groups, and aryl groups; R₃ is a linear or branched C₁-C₁₀-alkylene group, a C₆-C₁₀-arylene group, an -alkylarylene group or an -arylalkylene group; M is selected from the group consisting of calcium, magnesium, aluminum, zinc and mixtures thereof; m is 2 to 3; n is 1 or 3; and x is 1 or 2;
b2) at least one flame retardant synergist selected from the group consisting of phosphonate oligomers, polymers or copolymers; and optionally a metal hydroxide; and
b3) at least one cyclodextrin.

2. The flame retardant polymer composition of claim 1, comprising from at or about 18 to at or about 50 weight percent, based on the total weight of the flame retardant polymer composition, of the flame retardant mixture; and wherein b1) is present in the flame retardant mixture in an amount greater than or equal to 15 weight percent based on the total weight of the flame retardant polymer composition, and b2) is present in the flame retardant mixture in an amount such that the amount of b2) is less than the amount of b1).

3. The flame retardant polymer composition of claim 1, wherein the at least one flame retardant b1) is aluminum phosphinate, aluminum diethyl phosphinate or zinc diethyl phosphinate.

4. The flame retardant polymer composition of claim 1, wherein the cyclodextrin b3) is a β-cyclodextrin.

5. The flame retardant polymer composition of claim 1, wherein the amount of cyclodextrin b3) is greater than or equal to 5 weight percent, based on the total weight of the flame retardant composition.

6. The flame retardant polymer composition of claim 1, wherein b2) is a homopolymer polyphosphonate.

7. The flame retardant polymer composition of claim 6, wherein the amount of homopolymer polyphosphonate is greater than or equal to 1 weight percent based on the total weight of the flame retardant polymer composition.

8. The flame retardant polymer composition of claim 1, wherein b2) is a copolymer polyphosphonate.

9. The flame retardant polymer composition of claim 1, further comprising one or more metal deactivators or heat stabilizers or antioxidants.

10. The flame retardant polymer composition of claim 1, wherein the flame retardant mixture b) comprises b1) which is present in the flame retardant mixture in an amount from at or about 15 to 25 weight percent based on the total weight of the flame retardant polymer composition, b2) is present in the flame retardant mixture in an amount from at or about 1 to 15 weight percent based on the total weight of the flame retardant polymer composition and b3) is present in the flame retardant mixture in an amount from at or about 2 to 20 weight percent based on the total weight of the flame retardant polymer composition.

11. A molded, extruded, or shaped article comprising the flame retardant polymer composition of claim 1.

12. A wire or cable comprising a coating made of the flame retardant polymer composition of claim 1.

13. An optical cable comprising a coating made of the flame retardant polymer composition of claim 1.

14. A flame retardant composition consisting of:
A) at least one flame retardant comprising a material selected from the group consisting of phosphinates of the formula (I); disphosphinates of the formula (II); polymers of (I); polymers of (II); copolymers of (I) and (II); and mixtures of two or more of these phosphinates, diphosphinates, polymers and copolymers; 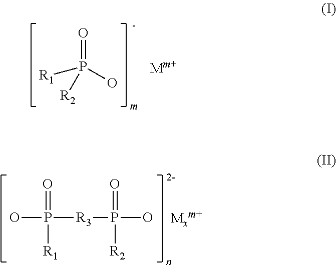
wherein R₁ and R₂ are independently selected from hydrogen, linear or branched C₁-C₆ alkyl groups, aryl groups and mixtures thereof; R₃ is a linear or branched C₁-C₁₀-alkylene group, a C₆-C₁₀-arylene group, an -alkylarylene group or an -arylalkylene group; M is selected from the group consisting of calcium, magnesium, aluminum, zinc and mixtures thereof; m is 2 to 3; n is 1 or 3; and x is 1 or 2,
B) at least one flame retardant synergist selected from the group consisting of phosphonate oligomers, polymers or copolymers; and optionally a metal hydroxide; and
C) at least one cyclodextrin,
wherein A) is present in the flame retardant composition in an amount from at or about 40 to at or about 85 weight percent, B) is present in the flame retardant mixture in an amount greater than 5 to at or about 25 weight percent, and C) is present in the flame retardant composition in an amount from at or about 10 to at or about 35 weight percent,
provided that the sum A)+B)+C) is 100 weight percent.

15. The flame retardant composition of claim 14, wherein the flame retardant synergist is a homopolymer polyphosphonate or a copolymer polyphosphonate.
